(19) United States
(12) Patent Application Publication
(10) Pub. No.: US 2015/0042530 A1
(43) Pub. Date: Feb. 12, 2015

(54) ANTENNA DEVICE

(71) Applicant: Hitachi Metals, Ltd., Tokyo (JP)

(72) Inventors: Nobuaki KITANO, Hitachi (JP); Tomoyuki OGAWA, Hitachi (JP); Naoki ISO, Hitachi (JP); Yoshiaki ISHIGAMI, Hitachi (JP)

(21) Appl. No.: 14/325,223

(22) Filed: Jul. 7, 2014

(30) Foreign Application Priority Data
Aug. 7, 2013 (JP) 2013-163954

(51) Int. Cl. H01Q 9/28

(52) U.S. Cl. CPC H01Q 9/285
USPC 343/793

(57) ABSTRACT

An antenna device includes an antenna element including a dielectric substrate including a first principal surface and a second principal surface, a built-in feed line provided on the first principal surface of the dielectric substrate, and a radiating element provided on the second principal surface of the dielectric substrate and along the built-in feed line so that the radiating element is fed from the built-in feed line, a triplate line including a first outer conductor and a second outer conductor parallel to each other, and a central conductor arranged therebetween to feed excitation power to the antenna element, a connecting member which electrically connects the central conductor and the built-in feed line, a projecting piece from one end of the dielectric substrate toward the second outer conductor, and a first hole and a second hole provided in the first outer conductor and in communication with each other. The first hole includes a first opposite surface to the connecting member with a specified space therebetween. The projecting piece is inserted in the second hole. The second hole includes an opposite regulating surface to the first principal surface of the projecting piece of the dielectric substrate, to regulate movement of the dielectric substrate toward the first opposite surface.

The present application is based on Japanese patent application No.2013-163954 filed on Aug. 7, 2013, the entire contents of which are incorporated herein by reference.

### BACKGROUND OF THE INVENTION

1. Field of the Invention

This invention relates to an antenna device, which includes a triplate line capable of feeding high frequency signal dependent excitation power to a plurality of antenna elements.

2. Description of the Related Art

As a conventional antenna device, a cross dipole antenna device has been known, which is configured as one pair of dielectric substrates combined together. Refer to JP-A-2009-124403, for example.

The antenna device described in JP-A-2009-124403 includes first and second rectangular dielectric substrates formed with a built-in feed line and a radiating element, and a square mount with the first and second dielectric substrates thereon. The first and second rectangular dielectric substrates are mounted in such a manner as to cross each other with their long side direction being parallel to the mount, and their short side direction being at right angles to the mount.

The first and second rectangular dielectric substrates are formed with respective engaging portions at both ends in the long side direction thereof, which project toward the mount, and a respective notch in a middle portion in the long side direction thereof, which extends in the short side direction. The mount is formed with elongated circle shaped engaged portions at its four corners, respectively, which each penetrate into the mount in a thickness direction of the mount. Also, in a middle portion of the mount are formed two round holes, which penetrate into the mount in the thickness direction of the mount, and is provided a feeding portion in which a feeding pin is soldered on an inner surface of the round hole with a coaxial cable or the like therebetween. Also, on a surface of the mount is formed a grounding short circuit pattern formed of a metal foil such as copper or the like.

The first dielectric substrate and the second dielectric substrate are fixed to the mount with their respective notches being meshed together and their respective engaging portions being inserted in the engaged portions respectively of the mount so that the first dielectric substrate and the second dielectric substrate are at right angles to each other. At this point, the respective built-in feed lines of the first and second dielectric substrates are electrically connected by bringing their respective tips extending toward the mount into contact with the feeding portion. Also, the respective radiating elements of the first and second dielectric substrates are extended toward the mount and shorted to ground at contacts respectively on the grounding short circuit pattern of the mount.

Refer to JP-A-2009-124403, for example.

### SUMMARY OF THE INVENTION

In the antenna device described in JP-A-2009-124403, due to the feeding portion configuration in which the feeding pin is soldered on the inner surface of the round hole formed in the mount with the coaxial cable or the like therebetween, no impedance matching in a connecting portion between the input side feeding portion and the output side built-in feed line is likely to occur, and high frequency signal transmission loss therein is high.

Accordingly, it is an object of the present invention to provide an antenna device, which is capable of lowering high frequency signal transmission loss in a connecting portion between a built-in feed line and a feeding portion.

According to an embodiment of the invention, an antenna device comprises:
an antenna element comprising a dielectric substrate including a first principal surface and a second principal surface, a built-in feed line provided on the first principal surface of the dielectric substrate, and a radiating element provided on the second principal surface of the dielectric substrate and along the built-in feed line so that the radiating element is fed from the built-in feed line;
a triplate line comprising a first outer conductor and a second outer conductor parallel to each other, and a central conductor arranged therebetween to feed excitation power to the antenna element;
a connecting member which electrically connects the central conductor and the built-in feed line;
a projecting piece from one end of the dielectric substrate toward the second outer conductor;
a first hole and a second hole provided in the first outer conductor and in communication with each other, the first hole including a first opposite surface to the connecting member with a specified space therebetween, the projecting piece being inserted in the second hole, the second hole including an opposite regulating surface to the first principal surface of the projecting piece of the dielectric substrate, to regulate movement of the dielectric substrate toward the first opposite surface.

In the embodiment, the following modifications and changes may be made.
(i) The connecting member comprises a smaller width direction dimension than a width direction dimension of the built-in feed line, where the width direction is parallel to the first principal surface.
(ii) The connecting member is being extended along the projecting piece inserted in the second hole from one end of the central conductor, and being joined to the built-in feed line.
(iii) The first opposite surface is opposite the connecting member with the space therebetween comprising a larger width than a thickness of the dielectric substrate, and the second hole includes a second opposite surface parallel to the first opposite surface, so that the built-in feed line and the first outer conductor constitute a triplate structure between the first opposite surface and the second opposite surface.
(iv) The antenna devices further comprises an electrically conductive member to electrically connect together the radiating element on the second principal surface of the dielectric substrate and the first outer conductor, the electrically conductive member and the radiating element being joined together in such a manner as to at least partially overlap the built-in feed line on the first principal surface in a thickness direction of the dielectric substrate.

### (Points of the Invention)

The antenna device according to the invention allows for lowering high frequency signal transmission loss in its connecting portion between the built-in feed line and the feeding portion.

### BRIEF DESCRIPTION OF THE DRAWINGS

The preferred embodiments according to the invention will be explained below referring to the drawings, wherein:

FIG. 1 is a block diagram showing a schematic configuration of an antenna device in an embodiment according to the present invention;

FIG. 2A is a perspective view showing an appearance of the antenna device as its specific configuration example;

FIG. 2B is a perspective view showing the antenna device with a first ground plate mounted therein as its specific configuration example;

FIG. 3 is an enlarged perspective view showing some antenna elements in FIG. 2B;

FIG. 4 is a perspective view showing the antenna device with a second ground plate mounted therein;

FIG. 5 is a perspective view showing a configuration example of an antenna element;

FIG. 6 is a plan view showing a configuration example of a horizontal polarized antenna element;

FIG. 7 is a plan view showing a configuration example of a vertical polarized antenna element;

FIG. 8 is an enlarged view showing a grounding portion and the surrounding area in FIG. 3;

FIG. 9 is a perspective view showing one example of a connecting structure between the vertical polarized antenna element and a central conductor;

FIG. 10A is a front view showing the vertical polarized antenna element and the center conductor connected together via a connecting pin;

FIG. 10B is a cross-sectional view taken along line A-A in FIG. 10A; and

FIG. 11 is a cross-sectional view showing a through-hole in the first ground plate and the surrounding area.

### DETAILED DESCRIPTION OF THE PREFERRED EMBODIMENTS

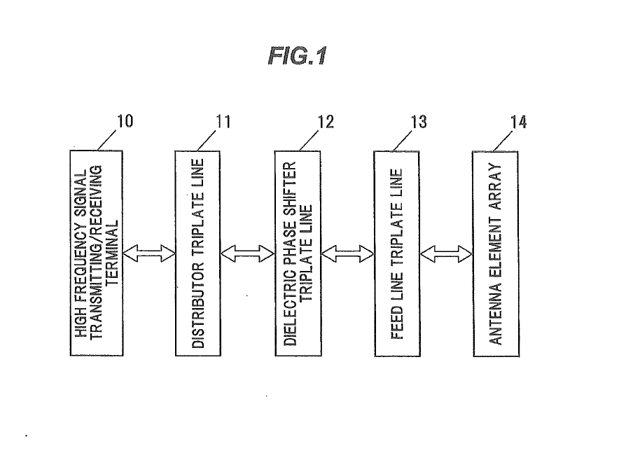

FIG. 1 is a block diagram showing a schematic configuration of an antenna device 1 in an embodiment according to the present invention.

This antenna device 1 is used as a mobile phone base station antenna device, for example, and is configured as including a high frequency signal transmitting or receiving terminal 10, a distributor the triplate line 11, a dielectric phase shifter the triplate line 12, a feed line the triplate line 13, and an antenna element array 14 with a plurality of antenna elements arranged in an array.

When excitation power depending on a high frequency transmission signal is input to the high frequency signal transmitting or receiving terminal 10, the excitation power is distributed by the distributor the triplate line 11. The excitation power distributed is imparted with a specified amount of phase shift by the respective corresponding the dielectric phase shifter the triplate line 12, and is input to the respective corresponding feed line the triplate line 13. The excitation power provided to the feed line the triplate lines 13 is fed to the respective corresponding antenna elements of the antenna element array 14, and is radiated with a specified directivity from each of the antenna elements.

Incidentally, although in this embodiment it is described that the antenna device 1 is used for transmission, this antenna device 1 may be used for reception as well, as indicated by double arrows in FIG. 1.

### (Configuration of the Antenna Device 1)

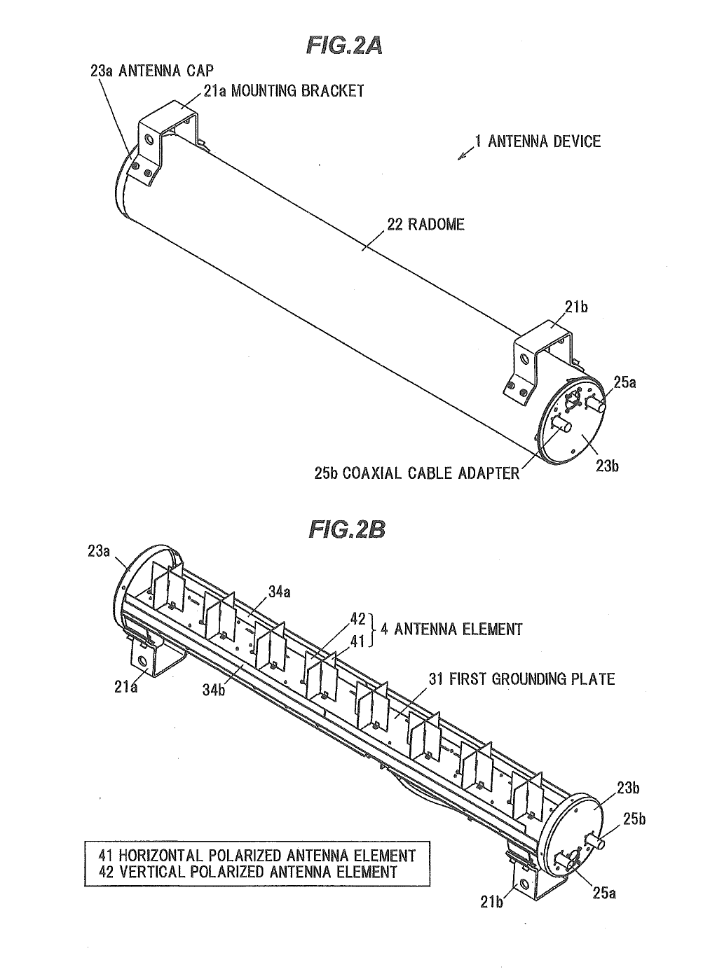

FIG. 2A is a perspective view showing an appearance of the antenna device 1 as its specific configuration example, and FIG. 2B is a perspective view showing the antenna device 1 with a first ground plate 31 mounted therein as its specific configuration example.

As shown in FIG. 2A, the antenna device 1 is configured as accommodating, in a circular cylindrical radome 22, the high frequency signal transmitting or receiving terminal 10, the distributor triplate line 11, the dielectric phase shifter triplate line 12, the feed line triplate line 13, the antenna element array 14, etc.

The radome 22 is closed by antenna caps 23a and 23b at both ends respectively thereof, and is mounted to an antenna tower or the like with mounting brackets 21a and 21b so that its longitudinal direction is a vertical direction. Also, coaxial cable adapters 25a and 25b acting as the high frequency signal transmitting or receiving terminal 10 (see FIG. 1) project outward from one antenna cap 23b.

As shown in FIG. 2B, a plurality (in the present embodiment eight) of the antenna elements 4 include a respective horizontal polarized antenna element 41 and a respective vertical polarized antenna element 42 and are arranged on the first ground plate 31 serving as a first conductor to constitute the antenna element array 14 (see FIG. 1). The first ground plate 31 is provided with side plates 34a and 34b on both sides in its width direction at right angles to its longitudinal direction.

The first ground plate 31 acts as a reflector that reflects electromagnetic waves radiated from the horizontal polarized antenna elements 41 and the vertical polarized antenna elements 42.

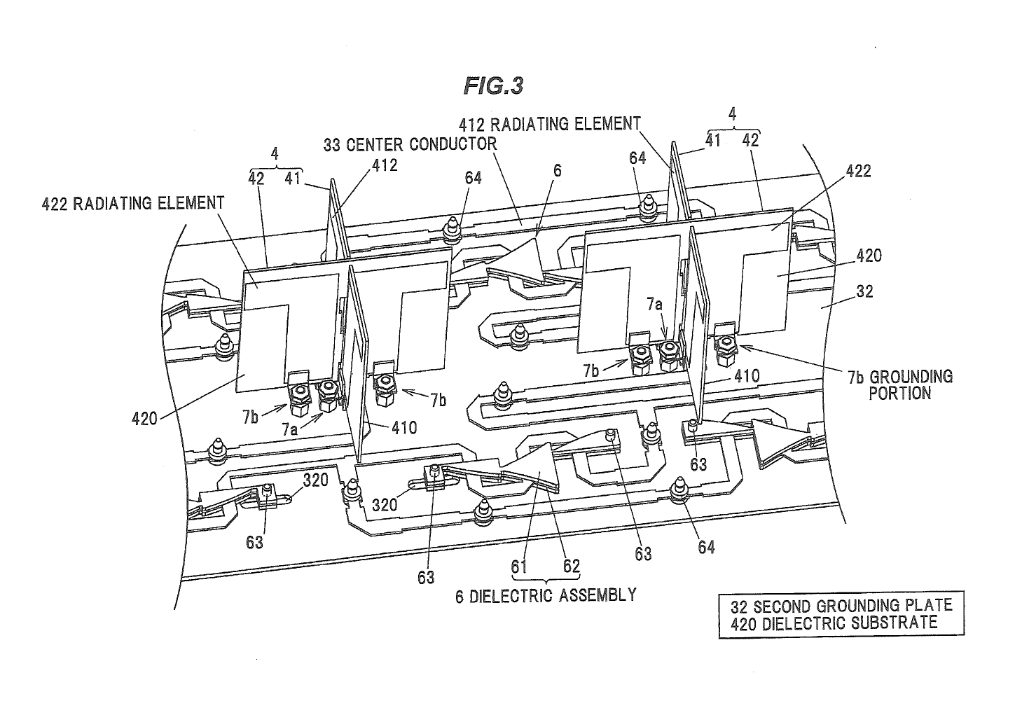

FIG. 3 is an enlarged perspective view showing some antenna elements 4 in FIG. 2B. Note that, in FIG. 3, no first ground plate 31 is shown, but a second ground plate 32, which is arranged parallel to the first ground plate 31, a central conductor 33, which is arranged between the first ground plate 31 and the second ground plate 32, and so on are shown.

The horizontal polarized antenna elements 41 are formed with a respective radiating element 412 on one surface of a rectangular dielectric substrate 410, and this radiating element 412 is connected by a plurality (in the present embodiment two) of grounding portions 7a to the first ground plate 31 not shown and the second ground plate 32 respectively serving as a second conductor. The first ground plate 31 and the second ground plate 32 are grounded by wiring not shown. Note that, in FIG. 3, only one grounding portion 7a of the two grounding portions 7a is shown.

In a similar fashion, the vertical polarized antenna elements 42 are formed with a respective radiating element 422 on one surface of a dielectric substrate 420, and this radiating element 422 is connected by a plurality (in the present embodiment two) of grounding portions 7b to the first ground plate 31 not shown and the second ground plate 32 respectively.

Between the first ground plate 31 (not shown) and the second ground plate 32 arranged parallel to each other, the plate shaped central conductor 33 is arranged parallel thereto, so that the first ground plate 31, the central conductor 33 and the second ground plate 32 constitute a triplate line.

In this embodiment, the distributor triplate line 11, the dielectric phase shifter triplate line 12 and the feed line triplate line 13 shown in FIG. 1 are configured as a series of triplate lines.

Between the central conductor 33 and the first ground plate 31, and between the central conductor 33 and the second ground plate 32 are provided a respective plurality of impedance matching dielectric spacers 64.

The central conductor 33 is sandwiched between a first dielectric plate 61 and a second dielectric plate 62 constituting a plurality of dielectric assemblies 6 which are provided in the triplate lines. The dielectric assemblies 6 are supported by one pair of dielectric supporting pins 63 at both ends thereof. The second ground plate 32 is formed with a plurality of elongated circle shaped slits 320 therein through which the dielectric supporting pins 63 respectively are passed.

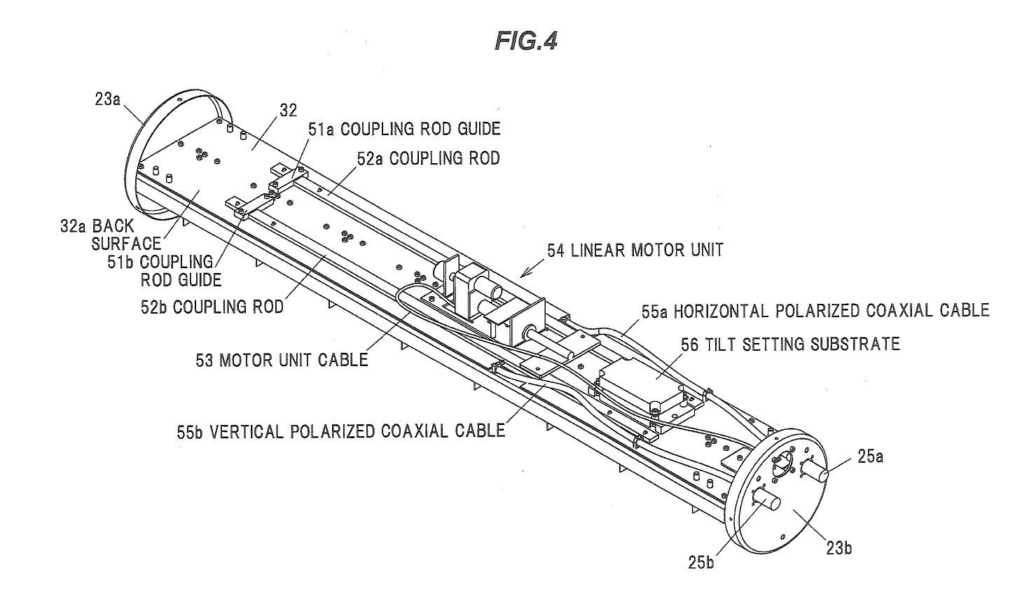

FIG. 4 is a perspective view showing the antenna device 1 with the second ground plate 32 mounted therein. Note that FIG. 4 shows the antenna device 1 viewed from opposite in FIG. 3, where the radome 22 is removed from the antenna device 1.

A back surface 32a (opposite surface to the surface opposite the central conductor 33) of the second ground plate 32 is provided with coupling rods 52a and 52b which are coupled to the dielectric supporting pins 63 (see FIG. 3). The coupling rods 52a and 52b are guided by coupling rod guides 51a and 51b, respectively, to move the dielectric supporting pins 63 in a longitudinal direction of the first ground plate 31.

Besides, the back surface 32a of the second ground plate 32 is provided with a linear motor unit 54 which is provided with a driving current by a motor unit cable 53 and a tilt setting substrate 56 to set a tilt angle.

Also, a horizontal polarized coaxial cable 55a, which is drawn from a coaxial cable adapter 25a to provide excitation power to the horizontal polarized antenna element 41, and a vertical polarized coaxial cable 55b, which is drawn from a coaxial cable adapter 25b to provide excitation power to the vertical polarized antenna element 42, are connected from the back surface 32a of the second ground plate 32 to the central conductor 33.

### (Configuration of the Antenna Element 4)

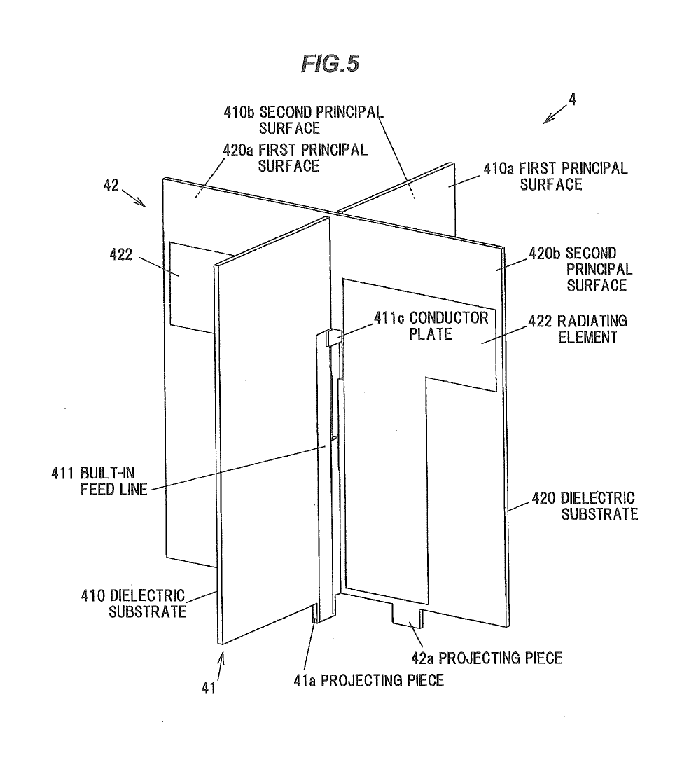

Next, a configuration of the antenna element 4 is described with reference to FIG. 5 to FIG. 7.

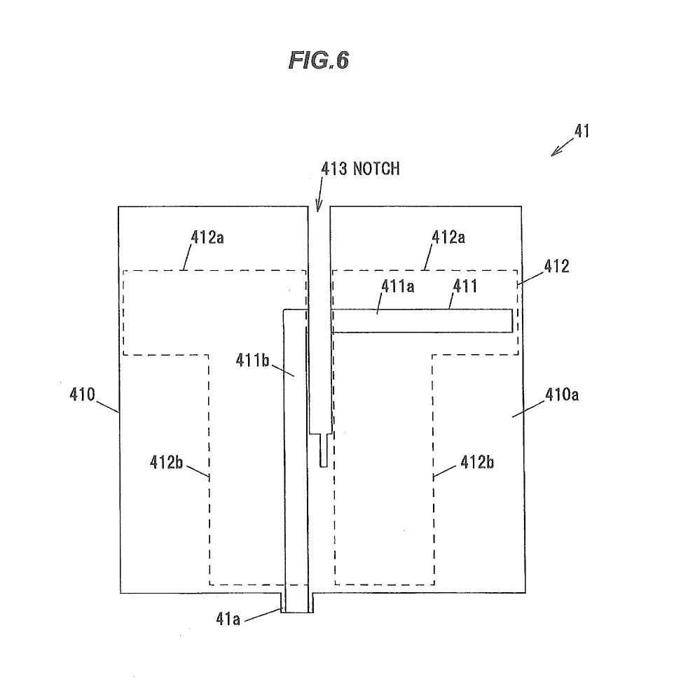

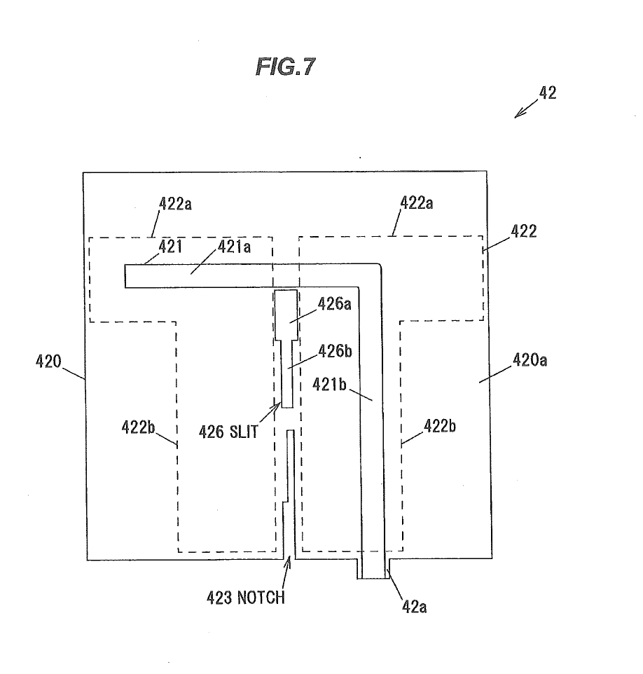

FIG. 5 is a perspective diagram showing a configuration example of the antenna element 4. FIG. 6 is a plan view showing a configuration example of the horizontal polarized antenna element 41. FIG. 7 is a plan view showing a configuration example of the vertical polarized antenna element 42.

As shown in FIGS. 5 and 6, the horizontal polarized antenna element 41 includes a dielectric substrate 410, a built-in feed line 411 formed on the first principal surface 410a of the dielectric substrate 410, and a radiating element 412 formed on the second principal surface 410b of the dielectric substrate 410. The radiating element 412 is formed along the built-in feed line 411 and is fed from the built-in feed line 411.

The dielectric substrate 410 includes a projecting piece 41a at one end thereof, which projects toward the second ground plate 32 (see FIG. 3). In this embodiment, the projecting piece 41a is formed adjacent to a middle portion in a parallel direction to the first ground plate 31 in the dielectric substrate 410.

Also, the dielectric substrate 410 is formed with a notch 413 in a middle portion in the parallel direction to the first ground plate 31, and which extends from an end opposite an end formed with the projecting piece 41a toward the end formed with the projecting piece 41a. In this embodiment, the notch 413 is formed in such a manner that its opening width is wider than its end width. In FIG. 6, the projecting piece 41a is formed in such a manner as to be located off an extension line of the notch 413.

The built-in feed line 411 is comprised of a first connection pattern 411a extending in the parallel direction to the first ground plate 31 and a second connection pattern 411b extending from an end of the first connection pattern 411a toward the projecting piece 41a. In this embodiment, the notch 413 is formed in such a manner as to cross the first connection pattern 411a, and the first connection pattern 411a portions divided by the notch 413 are connected together by a conductor plate 411c (shown in FIG. 5).

As indicated by broken lines in FIG. 6, the radiating element 412 is formed symmetrically with respect to the notch 413, and is comprised of a radiating element pattern 412a extending in the parallel direction to the ground plate 31, and a balun pattern 412b extending from a notch 413 side end of the radiating element pattern 412a and in an extending direction of the notch 413.

As shown in FIGS. 5 and 7, the vertical polarized antenna element 42 includes a dielectric substrate 420, a built-in feed line 421 fowled on the first principal surface 420a of the dielectric substrate 420, and a radiating element 422 formed on the second principal surface 420b of the dielectric substrate 420. The radiating element 422 is formed along the built-in feed line 421 and is fed from the built-in feed line 421.

The dielectric substrate 420 includes a projecting piece 42a at one end thereof, which projects toward the second ground plate 32 (see FIG. 3). Also, the dielectric substrate 420 is formed with, in a middle portion in the parallel direction to the first ground plate 31, a notch 423, which extends from its projecting piece 42a side and in a vertical direction to the first ground plate 31 and a slit 426 including a large slit portion 426a and a small slit portion 426b in communication with each other.

In this embodiment, the notch 423 is formed in such a manner that its opening width is wider than its end width. The slit 426 is arranged on the end side of the notch 423. In this embodiment, the small slit portion 426b is arranged in the notch 423 side.

The built-in feed line 421 is comprised of a first connection pattern 421a extending in the parallel direction to the first ground plate 31 and a second connection pattern 421b extending from an end of the first connection pattern 421a to the projecting piece 42a.

As indicated by broken lines in FIG. 7, the radiating element 422 is formed symmetrically with respect to the notch 423 and the slit 426, and is comprised of a radiating element pattern 422a extending in the parallel direction to the ground plate 31, and a balun pattern 422b extending from a slit 426 side end of the radiating element pattern 422a and continuously along the notch 423 and the slit 426.

As shown in FIG. 5, the antenna element 4 is assembled by meshing together the respective notches 413 and 423 of the horizontal polarized antenna element 41 and the vertical polarized antenna element 42. In this embodiment, the horizontal polarized antenna element 41 and the vertical polarized antenna element 42 are combined together at right angles to each other.

With the horizontal polarized antenna element 41 and the vertical polarized antenna element 42 combined together, the first connection pattern 411a formed with the notch 413 there across of the horizontal polarized antenna element 41 is connected in the large slit portion 426a of the vertical polarized antenna element 42 by the conductor plate 411c.

### (Grounding Between the Antenna Element 4 and the Triplate Line)

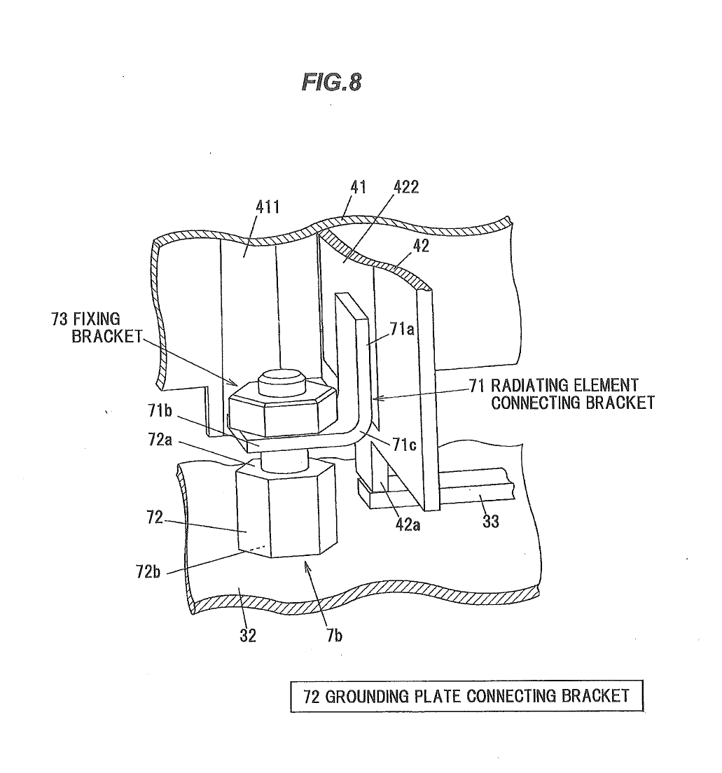

Next, the grounding between the antenna element 4 and the triplate line is described with reference to FIG. 8.

FIG. 8 is an enlarged view showing the grounding portion 7b and the surrounding area in FIG. 3. Note that, in FIG. 8, no first ground plate 31 is shown, as in FIG. 3.

The horizontal polarized antenna element 41 and the vertical polarized antenna element 42 of the antenna element 4 are grounded to the first ground plate 31 and the second ground plate 32 via the grounding portions 7a and 7b, respectively (see FIG. 3). Because the connecting structure between the horizontal polarized antenna element 41 and the grounding portion 7a, and the connecting structure between the vertical polarized antenna element 42 and the grounding portion 7b are similar to each other, the connecting structure between the vertical polarized antenna element 42 and the grounding portion 7b is taken as an example and described below.

The grounding portion 7b comprises a radiating element connecting bracket 71 as an electrically conductive member which connects the radiating element 422 of the vertical polarized antenna element 42 and the first ground plate 31 (not shown) together, a ground plate connecting bracket 72 which connects the first ground plate 31 and the second ground plate 32 together, and a fixing bracket 73 for fixing the radiating element connecting bracket 71 to the ground plate connecting bracket 72.

The radiating element connecting bracket 71 is formed by bending a plate into an L shape, and integrally includes a contact portion 71a extending in the parallel direction to the radiating element 422 of the vertical polarized antenna element 42 and in contact with the radiating element 422, a mounting portion 71b extending in the vertical direction to the contact portion 71a and being mounted with the fixing bracket 73, and a coupling portion 71c coupled between the contact portion 71a and the mounting portion 71b. The width direction dimension of the contact portion 71a and the mounting portion 71b is, for example, on the order of 6 mm. Note that the radiating element 422 and the contact portion 71a in contact with this radiating element 422 are fixed together by, for example, soldering, so as to ensure electrical connection between the radiating element 422 and the contact portion 71a of the radiating element connecting bracket 71 in the grounding portion 7b.

The joint between the radiating element 422 of the vertical polarized antenna element 42 and the radiating element connecting bracket 71 at least partially overlaps the built-in feed line 421 on the first principal surface 420a of the dielectric substrate 420 in the thickness direction of the dielectric substrate 420. In other words, the contact surface between the radiating element 422 and the contact portion 71a at least partially overlaps the second connection pattern 421b of the built-in feed line 421 when seen through in the vertical direction to the dielectric substrate 420.

The ground plate connecting bracket 72 is arranged between the first ground plate 31 and the second ground plate 32, and an upper surface 72a of the ground plate connecting bracket 72 is in contact with the first ground plate 31, and a lower surface 72b of the ground plate connecting bracket 72 is in contact with the second ground plate 32. In this embodiment, the ground plate connecting bracket 72 is shaped into a hexagonal cylinder, but may, instead, be shaped into, for example, a circular cylinder, a square cylinder, or the like.

### (The Connecting Structure Between the Antenna Element 4 and the Central Conductor 33)

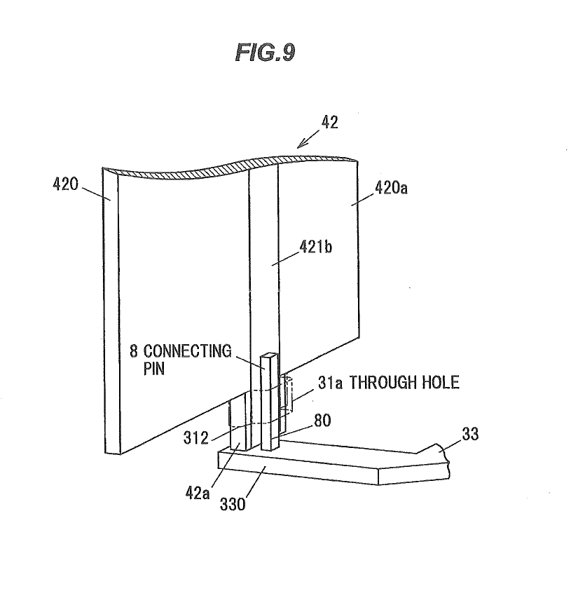

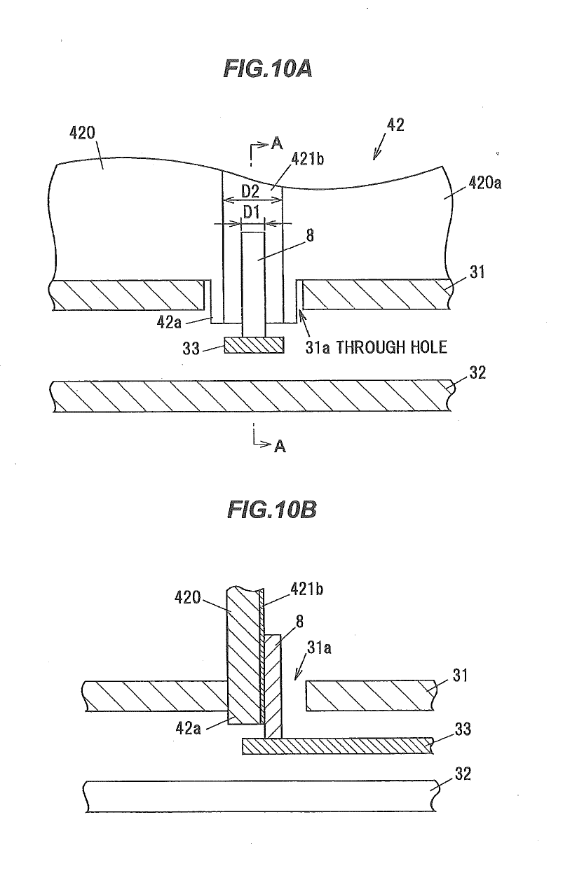

Next, a connecting structure between the antenna element 4 and the central conductor 33 of the triplate line is described with reference to FIGS. 9, 10A and 10B.

FIG. 9 is a perspective view showing one example of the connecting structure between the vertical polarized antenna element 42 and the central conductor 33. Note that, in FIG. 9, a through-hole 31a is indicated by alternate long and two short dashes line. FIG. 10A is a front view showing the vertical polarized antenna element 42 and the central conductor 33 connected together via a connecting pin 8, and FIG. 10B is a cross-sectional view taken along line A-A in FIG. 10A.

The built-in feed line 411 of the horizontal polarized antenna element 41 and the central conductor 33 are electrically connected together by the connecting pin 8 as a connecting member. Likewise, the built-in feed line 421 of the vertical polarized antenna element 42 and the central conductor 33 are electrically connected together by the connecting pin 8 as the connecting member. Because the connecting structure between the horizontal polarized antenna element 41 and the central conductor 33, and the connecting structure between the vertical polarized antenna element 42 and the central conductor 33 are similar to each other, the connecting structure between the vertical polarized antenna element 42 and the central conductor 33 is taken as an example and described below.

The connecting pin 8 is fixed, for example, by soldering at an end 80 thereof to an end 330 of the central conductor 33, is extended along the projecting piece 42a inserted in the second hole 312 (indicated by the alternate long and two short dashes line in FIG. 9) of the through-hole 31a formed in the first ground plate 31 (not shown), is passed through the through-hole 31a, and is connected, for example, by soldering to the second connection pattern 421b of the built-in feed line 421. This results in the central conductor 33 and the built-in feed line 421 being electrically connected together via the connecting pin 8.

The connecting pin 8 is shaped into a quadrangular prism in the present embodiment, and, as shown in FIG. 10A, a width direction dimension D₁ of the connecting pin 8 is smaller than a width direction dimension D₂ of the built-in feed line 421 (the second connection pattern 421b), where the width direction is parallel to the first principal surface 420a of the dielectric substrate 420. Note that the shape of the connecting pin 8 is not limited to the quadrangular prism shape, but may be, for example, a circular cylindrical shape.

As shown in FIG. 10B, the projecting piece 42a of the vertical polarized antenna element 42 is arranged at right angles to the central conductor 33. Therefore, the connecting pin 8 extends vertically relative to the central conductor 33. Also, a tip of the projecting piece 42a is not in contact with the end 330 of the central conductor 33, but the projecting piece 42a and the end 330 of the central conductor 33 are arranged with a gap therebetween.

(Configuration of the Through-Hole 31a)

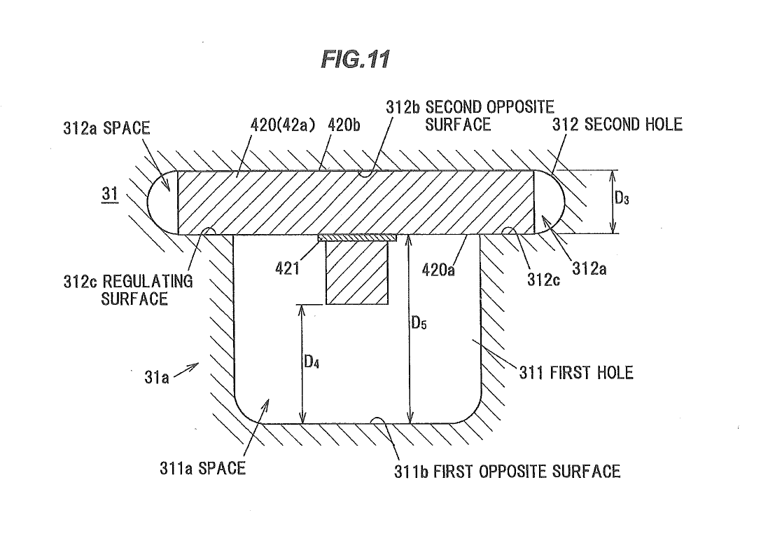

Next, the through-hole 31a formed in the first ground plate 31 is described with reference to FIG. 11.

FIG. 11 is a sectional view showing the through-hole 31a in the first ground plate 31. Note that FIG. 11 shows the through-hole 31a in which the projecting piece 42a of the vertical polarized antenna element 42 is being inserted in a second hole 312 of the through-hole 31a.

The through-hole 31a includes a first hole 311 and a second hole 312 in communication with each other. The projecting piece 42a of the vertical polarized antenna element 42 is inserted in the second hole 312. In this embodiment, the second hole 312 is formed larger in a dimension parallel to the width direction of the projecting piece 42a of the vertical polarized antenna element 42 than the first hole 311.

The first hole 311 includes a first opposite surface 311b which is opposite the connecting pin 8 with a space 311a therebetween, where the connecting pin 8 is being connected to the built-in feed line 421 (the second connection pattern 421b). A distance D₄ between the connecting pin 8 and the first opposite surface 311b is larger than a thickness D₃ of the dielectric substrate 420 of the vertical polarized antenna element 42. That is, the first opposite surface 311b is opposite the connecting pin 8 with the space 311a therebetween comprising the larger width D₄ than the thickness D₃ of the dielectric substrate 420.

In this embodiment, the thickness D₃ of the dielectric substrate 420 is 1 mm, and the distance D₅ between the first principal surface 420a of the dielectric substrate 420 and the first opposite surface 311b of the first hole 311 is 3 mm, and the distance D₄ between the connecting pin 8 and the first opposite surface 311b is 2 mm.

Note that the thickness D₃ of the dielectric substrate 420, the distance D₄ between the connecting pin 8 and the first opposite surface 311b, and the distance D₅ between the first principal surface 420a of the dielectric substrate 420 and the first opposite surface 311b of the first hole 311 are not limited to the above mentioned dimensions, but, if D₃<D₄<D₅, may be configured freely according to application of the antenna device 1.

The second hole 312 includes a second opposite surface 312b parallel to the first opposite surface 311b, and a regulating surface 312c, which is opposite the second opposite surface 312b to regulate movement of the dielectric substrate 420 toward the first opposite surface 311b.

More specifically, the second opposite surface 312b is opposite the second principal surface 420b of the projecting piece 42a of the vertical polarized antenna element 42 inserted in the second hole 312 of the through-hole 31a, and the regulating surface 312c is opposite the first principal surface 420a of the projecting piece 42a.

The projecting piece 42a of the vertical polarized antenna element 42 is sandwiched between the second opposite surface 312b and the regulating surface 312c in the through-hole 31a, so that the movement of the projecting piece 42a in the thickness direction of the dielectric substrate 420 is regulated.

In this embodiment, the second hole 312 is shaped into an elongated circle, and spaces 312a are formed between the projecting piece 42a and inner surfaces of the second hole 312 at both ends, respectively, in the width direction of the projecting piece 42a. In this embodiment, the second hole 312 is shaped into the elongated circle, but may, instead, be shaped into, for example, a rectangle. Also, the spaces 312a are not necessarily required.

Also, the built-in feed line 421 (the second connection pattern 421b) on the projecting piece 42a of the vertical polarized antenna element 42 is arranged parallel to between the first opposite surface 311b and the second opposite surface 312b, so that the built-in feed line 421 (the second connection pattern 421b) and the first ground plate 31 constitute a triplate structure to allow impedance matching in the through-hole 31a. The impedance (characteristic impedance) in the through-hole 31a is set at, for example, 50 Ω.

In this triplate structure, the distance D₄ between the connecting pin 8 and the first opposite surface 311b is configured as being greater than the thickness D₃ (D₄>D₃) of the dielectric substrate 420, and the width direction dimension D₁ of the connecting pin 8 is smaller than the width direction dimension D₂ (D₁<D₂) of the built-in feed line 421 (the second connection pattern 421b), where the width direction is parallel to the first principal surface 420a of the dielectric substrate 420. The impedance matching in the through-hole 31a can therefore be done by adjusting the width direction dimension D₂ of the built-in feed line 421 (the second connection pattern 421b).

### (Functions and Advantageous Effects of the Present Embodiment)

The embodiment described above has the following functions and advantageous effects.

(1) The regulating surface 312c of the second hole 312 regulates the movement of the projecting piece 41a or 42a inserted in the second hole 312 of the through-hole 31a toward the first opposite surface 311b, and can thereby maintain the good spacing between the connecting pin 8 joined to the built-in feed line 411 or 421 and the first opposite surface 311b of the first hole 311. This facilitates matching the output impedance of the central conductor 33 (the triplate line) and the input impedance of the antenna element 4.

(2) The built-in feed line 411 or 421 on the projecting piece 41a or 42a of the antenna element 4 and the first ground plate 31 constitute the triplate structure between the first opposite surface 311b and the second opposite surface 312b parallel to each other of the through-hole 31a, and can thereby stabilize impedance and lower high frequency signal transmission loss in the connecting portion between the built-in feed line 411 or 421 and the central conductor 33, as compared with when a coaxial cable or the like is used therebetween.

(3) The built-in feed line 411 or 421 of the antenna element 4 and the central conductor 33 are electrically connected together via the connecting pin 8, and can thereby ensure the simplification of the connecting structure between the built-in feed line 411 or 421 of the antenna element 4 and the central conductor 33 of the triplate line.

(4) In the triplate structure in the through-hole 31a, the distance D₄ between the connecting pin 8 and the first opposite surface 311b is configured as being greater than the thickness D₃ (D₄>D₃) of the dielectric substrate 420, and the width direction dimension D₁ of the connecting pin 8 is smaller than the width direction dimension D₂ (D₁<D₂) of the built-in feed line 421 (the second connection pattern 421b), where the width direction is parallel to the first principal surface 420a of the dielectric substrate 420. The impedance matching can therefore be done with the width direction dimension D₂ of the built-in feed line 421 (the second connection pattern 421b). Also, for example, even if the connecting pin 8 is tilted slightly relative to the vertical direction to the central conductor 33, the connecting pin 8 fits in the width direction dimension D₂ of the built-in feed line 421 (the second connection pattern 421b). The impedance of the connecting portion between the built-in feed line 411 or 421 and the central conductor 33 is therefore stable.

(5) The contact portion 71a of the radiating element connecting bracket 71 connected with the radiating element 412 or 422 of the antenna element 4 at least partially overlaps the built-in feed line 411 or 421 on the first principal surface 410a or 420a of the dielectric substrate 410 or 420 in the thickness direction of the dielectric substrate 410 or 420. That is, the high frequency signal transmission loss can be lowered by grounding adjacent to the connecting portion between the built-in feed line 411 or 421 and the central conductor 33.

(6) Because the built-in feed line 411 or 421 of the antenna element 4 is joined by soldering or the like to the connecting pin 8, replacement of the antenna element 4 is facilitated.

### Summary of the Embodiment

Next, the technical concept that is ascertained from the embodiment described above will be described with the aid of reference characters and the like in the embodiment. It should be noted, however, that each of the reference characters in the following description should not be construed as limiting the constituent elements in the claims to the members and the like specifically shown in the embodiment.

[1] An antenna device (1), comprising: an antenna element (4) comprising a dielectric substrate (410, 420) including a first principal surface (410a, 420a) and a second principal surface (410b, 420b), a built-in feed line (411, 421) provided on the first principal surface (410a, 420a) of the dielectric substrate (410, 420), and a radiating element (412, 422) provided on the second principal surface (410b, 420b) of the dielectric substrate (410, 420) and along the built-in feed line (411, 421) so that the radiating element (412, 422) is fed from the built-in feed line (411, 421); a triplate line comprising a first outer conductor (first ground plate 31) and a second outer conductor (second ground plate 32) parallel to each other, and a central conductor (33) arranged therebetween to feed excitation power to the antenna element (4); a connecting member (8) which electrically connects the central conductor (33) and the built-in feed line (411, 421); a projecting piece (41a, 42a) from one end of the dielectric substrate (410, 420) toward the second ground plate (32); a first hole (311) and a second hole (312) provided in the first ground plate (31) and in communication with each other, the first hole (311) including a first opposite surface (311b) to the connecting pin (8) with a specified space (311a) therebetween, the projecting piece (41a, 42a) being inserted in the second hole (312), the second hole (312) including an opposite regulating surface (312c) to the first principal surface (410a, 420a) of the projecting piece (41a, 42a) of the, dielectric substrate (410, 420), to regulate movement of the dielectric substrate (410, 420) toward the first opposite surface (311b).

[2] The antenna device (1) according to [1] above, wherein the connecting pin (8) comprises a smaller width direction dimension (D₁) than a width direction dimension (D₂) of the built-in feed line (411, 421), where the width direction is parallel to the first principal surface (410a, 420a).

[3] The antenna device (1) according to [1] above, wherein the connecting pin (8) is being extended along the projecting piece (41a, 42a) inserted in the second hole (312) from one end of the central conductor (33), and being joined to the built-in feed line (411, 421).

[4] The antenna device (1) according to [1] above, wherein the first opposite surface (311b) is opposite the connecting pin (8) with the space (311a) therebetween comprising a larger width (D₄) than a thickness (D₃) of the dielectric substrate (410, 420), and the second hole (312) includes a second opposite surface (312b) parallel to the first opposite surface (311b), so that the built-in feed line (411, 421) and the first ground plate 31 constitute a triplate structure between the first opposite surface (311b) and the second opposite surface (312b).

[5] The antenna device (1) according to [1] above, further comprising an electrically conductive member (radiating element connecting bracket 71) to electrically connect together the radiating element (412, 422) on the second principal surface (410b, 420b) of the dielectric substrate (410, 420) and the first ground plate (31), the radiating element connecting bracket (71) and the radiating element (412, 422) being joined together in such a manner as to at least partially overlap the built-in feed line (411, 421) on the first principal surface (410a, 420a) in a thickness direction of the dielectric substrate (410, 420).

Although the embodiment of the present invention has been described above, the embodiment described above should not be construed as limiting the invention in the appended claims. It should also be noted that not all the combinations of the features described in the above embodiment are essential to the means for solving the problems of the invention.

The present invention may be appropriately modified and practiced without departing from the spirit thereof. For example, although in the above embodiment the dielectric substrate 410 of the horizontal polarized antenna element 41 and the dielectric substrate 420 of the vertical polarized antenna element 42 are each rectangular, the shape of the dielectric substrates 410 and 420 are not limited thereto, but may be altered according to application of the antenna device 1.

Also, the antenna device 1 is not limited to use for the mobile phone base station, but the invention may be applied to antenna devices in various applications.

Also, the wiring patterns of the built-in feed lines 411 and 421 and the radiating elements 412 and 422 of the antenna element 4 are not particularly limited, but may be altered according to application of the antenna device 1.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An antenna device, comprising:
an antenna element comprising a dielectric substrate including a first principal surface and a second principal surface, a built-in feed line provided on the first principal surface of the dielectric substrate, and a radiating element provided on the second principal surface of the dielectric substrate and along the built-in feed line so that the radiating element is fed from the built-in feed line;
a triplate line comprising a first outer conductor and a second outer conductor parallel to each other, and a central conductor arranged therebetween to feed excitation power to the antenna element;
a connecting member which electrically connects the central conductor and the built-in feed line;
a projecting piece from one end of the dielectric substrate toward the second outer conductor;
a first hole and a second hole provided in the first outer conductor and in communication with each other, the first hole including a first opposite surface to the connecting member with a specified space therebetween, the projecting piece being inserted in the second hole, the second hole including an opposite regulating surface to the first principal surface of the projecting piece of the dielectric substrate, to regulate movement of the dielectric substrate toward the first opposite surface.

2. The antenna device according to claim 1, wherein the connecting member comprises a smaller width direction dimension than a width direction dimension of the built-in feed line, where the width direction is parallel to the first principal surface.

3. The antenna device according to claim 1, wherein the connecting member is being extended along the projecting piece inserted in the second hole from one end of the central conductor, and being joined to the built-in feed line.

4. The antenna device according to claim 1, wherein the first opposite surface is opposite the connecting member with the space therebetween comprising a larger width than a thickness of the dielectric substrate, and the second hole includes a second opposite surface parallel to the first opposite surface, so that the built-in feed line and the first outer conductor constitute a triplate structure between the first opposite surface and the second opposite surface.

5. The antenna device according to claim 1, further comprising an electrically conductive member to electrically connect together the radiating element on the second principal surface of the dielectric substrate and the first outer conductor, the electrically conductive member and the radiating element being joined together in such a manner as to at least partially overlap the built-in feed line on the first principal surface in a thickness direction of the dielectric substrate.
